(19) United States
(12) Patent Application Publication
(10) Pub. No.: US 2009/0208666 A1
(43) Pub. Date: Aug. 20, 2009

(54) DIAMOND COATED SURFACES

(76) Inventors: Christopher John Howard Wort, Oxfordshire (GB); Geoffrey Alan Scarsbrook, Berkshire (GB); Timothy Peter Mollart, Berkshire (GB)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/577,766

(22) PCT Filed: Oct. 20, 2005
(86) PCT No.: PCT/IB05/03134

§ 371 Date: Apr. 23, 2007

Related U.S. Application Data
(60) Provisional application No. 60/623,238, filed on Nov. 1, 2004.

(30) Foreign Application Priority Data
Oct. 21, 2004 (GB) 04234191.1

(51) Int. Cl. B05D 3/06

(52) U.S. Cl. 427/551

(57) ABSTRACT

A method of producing a diamond coated surface on a substrate. A surface of the substrate is prepared by exposing it to a power beam, such as an electron beam, to increase the surface area and surface roughness. Such preparation may also provide the surface with three dimensional features onto which a diamond layer can adhere and mechanically lock. Adhesion of a diamond layer applied to the prepared surface is increased.

### BACKGROUND OF THE INVENTION

THIS invention relates to diamond coated surfaces.

Substrates with diamond coated surfaces are used in a variety of applications such as in cutting tools, optical devices, electronic devices and heat sinks. Other applications include wear applications, such as load bearing wear surfaces or surfaces exposed to an abrasive environment such as abrasive or particle containing fluids.

A key problem in applying diamond to many of these applications is matching the diamond to the surface onto which it is applied, and achieving sufficient adhesion to avoid delamination or failure at the interface under the conditions applied by the application. For example, many metals have a much higher expansion coefficient than diamond, resulting in thermal stresses from the high diamond deposition temperature or temperature of application. A common solution employed is the use of interface coatings, which may be intended to either enhance adhesion or minimize interface stresses, but these are often not sufficient. As well as metals, other important substrate materials on which it would be desirable to apply diamond coatings include carbides, such as tungsten carbide, and ceramics.

As a particular example, it has been suggested that diamond coated substrates can be used in prosthetic applications, particularly for prosthetic joints such as hip joints. U.S. Pat. No. 5,645,601 describes a prosthetic joint comprising a ball mounted on a stem and capable of being received by a complementally shaped socket or recess in a second component. The contacting surfaces of the ball and socket are coated with polycrystalline diamond compact. A significant problem in producing a successful joint of this nature is the bonding of the polycrystalline diamond compact to the ball and socket surfaces respectively. The ball and socket surfaces will generally be metal and problems of thermal mismatch between the diamond and the metal do arise leading to a risk of delamination. The nature of the application means that delamination failures cannot be tolerated.

Similar problems arise when prosthetic joints use other forms of diamond such a CVD diamond as the diamond coating. Interface coatings may be used to enhance adhesion, but all additional materials need to be carefully considered for their biocompatibility, and the reliability of such coatings is generally not sufficient.

### SUMMARY OF THE INVENTION

According to the present invention, a method of producing a diamond coated surface on a substrate includes the steps of preparing a surface of the substrate by exposing it to a power beam to increase the surface roughness, and optionally to provide a surface with three dimensional features onto which a diamond layer can adhere and mechanically lock, and applying a diamond layer to the prepared surface.

### DESCRIPTION OF EMBODIMENTS

The first step in the method of the invention is to expose a surface of the substrate to a power beam to increase the surface area and the surface roughness of that surface, and possibly in addition to provide re-entrant or other mechanical locking features on the surface. Adhesion of the diamond layer applied to or deposited on this surface is thus increased. The exposure of the surface will preferably involve exposing a number of locations, generally periodically spaced locations, to the power beam. Depending on the nature of the substrate, the locations exposed to the power beam will melt and then solidify forming a number of cavities or recesses in the surface, possibly with material displaced from these cavities forming related features extending above the original surface of the substrate, in a manner described in EP 0 626 228. In one preferred form of this method, the power beam is caused to traverse each location being exposed in the manner described in WO 02/094497, which is incorporated herein by reference. In this way a more effective surface roughening is achieved and better adhesion between substrate surface and diamond layer.

The power beam may be a laser beam or other electromagnetic beam, or an e-beam or other particle beam. A preferred embodiment utilizes an electron beam as the power beam.

The characteristic dimensions of the surface features generated by the power beam depend on the beam conditions, such as the beam diameter, the beam power density, the traverse rate and the beam path used. Typical size ranges for the surface features that stand above the surface are heights and diameters in the range 5 μm to 1000 μm, with the height typically, but not necessarily, being greater than the diameter. For plain holes in the surface, typical dimensions are in the range 5 μm to 1000 μm. When making a hole in the surface, the beam can be steered to make the hole re-entrant, that is, the opening where hole meets the general surface having a diameter that is smaller than the nominal diameter of the hole. The nominal diameters of re-entrant holes are typically in the range 5 μm to 1000 μm, with the surface opening typically being between 25% and 75% of the nominal diameter.

The centre-to-centre spacing between features is chosen so that it is typically in the range 1.5 to 20 times the diameter of the feature. However it is possible to deliberately overlap the surface features.

The dimensions of the features are chosen with regard to the final diamond layer thickness, as it is necessary that these features do not protrude through the top of the diamond layer. It is preferred that the vertical dimension of the features is between 5% and 80% of the thickness of the final diamond layer thickness, and more preferably between 15% and 50% of the final diamond layer thickness.

The surface features are preferably prepared such that they are in a periodic array. Whilst any kind of periodic array is suitable, preferred periodic arrays include hexagonal arrays, in which each feature has as its nearest neighbouring features six other uniformly disposed features, square arrays, in which each feature has as its nearest neighbouring features four other uniformly disposed features, and rectangular arrays, in which the array has two-fold rotational symmetry and two mirror symmetry axes at 90° to each other. Two further preferred feature arrays are a parallelogram array, in which the array has two-fold rotational symmetry and no mirror symmetry, and a rhombus array, in which the array has four-fold rotational symmetry and no mirror symmetry. By using regular arrays, the programming of the power beam is greatly simplified.

It is also possible to mix two or more types of surface feature, for example re-entrant holes can be combined with features which protrude above the surface.

An example of a surface feature array generated by a power beam could be a hexagonal array of 20 μm diameter, 50 μm high pillars that are spaced 75 μm apart.

Prior to diamond synthesis, it is general practice to ‘seed’ or prepare the surface for diamond nucleation. Typically methods for this process have been developed for flat surfaces, and include methods such as abrasion or polishing with diamond grit. The exact mechanism by which this improves nucleation is still uncertain, although a key feature is believed to be the provision of sharp features and possibly the embedding of small diamond or predominantly sp³ bonded carbon fragments.

In this invention, the surface of the material to be seeded is no longer planar and conventional mechanical methods of seeding are generally insufficient. Furthermore, the process of melting and re-solidifying of the surface of the substrate tends to produce rounded asperities which are not good nucleation points in their own right. One method of seeding that can be performed uses an ultrasonic method, in which the surface is placed in a suspension of diamond particles in a fluid and the fluid agitated by ultrasonic means. An alternative technique utilizes a gas stream or a liquid stream containing suspended diamond particles directed at the surface with suitable velocity.

The diamond layer may then be applied to the prepared and seeded surface of the substrate by methods known in the art. The preferred method is to deposit a diamond layer on the prepared surface by chemical vapour deposition (CVD). The method of synthesis must be selected to be compatible with the surface structure of the substrate. For example, metal surfaces with sharp asperities are not compatible with all methods of microwave synthesis, since the microwave energy can be coupled preferentially in the region of the asperity and cause etching and re-deposition of the asperities, modifying the surface and reducing the quality and adhesion of the diamond film. Under such circumstances, techniques such as hot filament deposition or jet deposition techniques may be more advantageous. In addition, a heavily structured surface, with large asperities and deep pits, is only taken full advantage of if the deposited diamond film fills the free space at the surface of the substrate so that no cavities are left at the interface. Conventional deposition techniques do not generally achieve this, since the gas flow velocity is insufficient in the region of the surface and depletion of carbon species at the asperities and other higher points causes the cavities and other lower points not to be completely filled. The solution is to select a method in which the gas velocity at the surface is enhanced. Methods include gas jets, which can be combined with methods such as microwave and hot filament deposition or result from the use of more conventional jet technology such as plasma jets.

The diamond layer produced is polycrystalline in nature, with a key property being the grain size. Preferably the grain size in the region of the interface should be significantly smaller than the characteristic spacing of the periodic features and more preferably, small compared to the typical radius of curvature that characterises the features generated in the roughening process. To achieve this it is again important to control the nucleation density, and also the growth conditions during the early stage of growth to avoid excessively rapid grain size growth as the film thickness increases in the interface region.

The substrate material will vary according to the nature of the application to which the product of the method is intended to be put. The substrate material may be ceramic such as a carbide, nitride, oxide or the like or a metal. Particular metals where the method is of utility are tungsten, titanium and molybdenum, and alloys of these metals, in particular alloys containing predominantly these metals. The method of the invention has particular application to producing a product comprising a metal substrate having a diamond layer bonded to a surface thereof. The method, it has been found, greatly improves the bonding of the diamond layer to the metal substrate and reduces the risk of delamination caused by thermal expansion mismatch.

The product of the method of the invention may be used in a variety of applications such as in electronic or optical devices, cutting tools, drill bits, heat sinks and for low friction bearing or wear surfaces such as in load bearing applications.

Load bearing applications include prosthetic joints such as hip joints. In a hip or similar joint, the method may be used to produce a diamond coated ball, a diamond coated socket or both a diamond coated ball and a diamond coated socket. The substrate for the ball and socket will typically be a metal such as titanium or a titanium-containing alloy, or tungsten or a tungsten containing alloy.

Diamond bearing and load bearing wear surfaces are used in a number of other applications, such as rotating seal faces, shaft bearings, etc.

Another type of application is in valves, nozzles and other flow containment components for fluids containing abrasive particles. Here the failure mechanism may be a complex combination of thermal, mechanical, impact and abrasion mechanisms, each of which can assist in failure of the component by interface failure and delamination of the diamond layer.

The invention will now be described, by way of example only, with reference to the following non-limiting examples.

### EXAMPLE 1

One substrate onto which it is desirable to grow highly adherent diamond layers is molybdenum. It is normally found that CVD diamond does not adhere well to molybdenum and molybdenum alloys. This is believed to be a result of the combined effects of the thermal expansion mismatch between diamond and molybdenum and the nature of the molybdenum carbide layer formed at the interface.

In this example a molybdenum substrate (commercial purity), 50 mm in diameter and 5.0 mm thick, was treated with a power beam consisting of a focused beam of electrons as described in WO 02/094497. An area, approximately 10 mm by 10 mm, consisting of re-entrant holes a few 10s of micrometers deep and in diameter was formed on the surface of the molybdenum.

After surface structuring, the substrate was ultrasonically seeded using fine (2-4 μm) diamond powder, cleaned with propan-2-ol to remove any residue from the seeding process and then placed in a microwave-assisted chemical vapour deposition system used for polycrystalline diamond synthesis. The conditions used for synthesis were a process gas consisting of 1.5% methane, balance hydrogen, at a pressure of 14×10³ Pa (110 Torr) and a total gas flow rate of approximately 500 sccm. The growth temperature measured using an optical pyrometer was between 790° C. and 850° C. Growth was terminated when the layer thickness reached approximately 100 μm.

On removing the molybdenum substrate from the synthesis system, the diamond layer grown on the area that had not previously been treated with the electron beam was found to be very weakly adhered and could easily be prised-off using a scalpel blade. However, the material grown on the area treated with the power beam was extremely well adhered and could not be removed, even by thermal shocking the layer to −196° C. with liquid nitrogen.

The polycrystalline CVD diamond layer grown on the power beam treated area has been demonstrated to be much more adherent than the layer grown under the same conditions on the untreated area.

### EXAMPLE 2

A second highly desirable substrate material to which it is difficult to get CVD diamond to reliably adhere to is titanium and its alloys. The reason is the very high thermal expansion coefficient of titanium (approximately 7 ppm per ° C. at room temperature), which results in the diamond delaminating during cooling from the synthesis temperature.

In this example, diamond coated titanium alloy is intended for use as an electrode material for electrochemical processes.

A piece of titanium alloy (Ti-6Al-4V) was treated with a power beam as in Example 1, but under slightly different conditions so as to form a surface layer containing re-entrant holes between 25 and 50 μm deep and of a similar diameter. The surface structured substrate was then seeded as described in Example 1.

A microwave plasma CVD technique was used to deposit the boron doped diamond layer. Diamond deposition was performed in a microwave CVD system such as is well known in the art. The total gas flow was in the region of 3000 sccm, comprising 1% methane, 1% argon, balance hydrogen with diborane (B₂H₆) added such that the diborane to methane ratio is 0.06%. The exact diborane to methane ratio required to achieve a given resistivity is a sensitive function of the exact deposition conditions and, as those skilled in the art will be aware, can vary substantially between synthesis systems. The diborane was added with hydrogen as a dilutant, in this case as 500 ppm diborane in hydrogen. The total hydrogen in the gas mixture includes the hydrogen used to dilute the diborane. The pressure in the chamber during deposition was 18×10³ Pa (140 Torr). Deposition continued until the layer thickness was approximately 200 μm, the exact thickness being unimportant.

The resultant diamond coating on the surface structured titanium alloy did not delaminate on cooling from the deposition temperature, indicating good adhesion. In a similar experiment with the same titanium alloy and synthesis conditions, but without the pre-synthesis surface structuring, the CVD diamond layer had already delaminated when it was removed from the synthesis system.

### EXAMPLE 3

In this example, a high purity tungsten substrate shaped into a 270° segment of a sphere (radius approximately 18 mm) is coated in a hot filament CVD system, with the intention of using it as a femoral head in a replacement hip joint.

Although tungsten is a very good substrate for CVD diamond synthesis, adhesion between the diamond layer and the substrate can be a problem, and in situations where the reliability of adhesion is essential, steps must be taken to ensure that adhesion is maintained. In this example, the substrate surface was subjected to a power beam treatment to form a more-or-less regular array of protrusions from the surface. The protrusions were typically 50-80 μm tall with a diameter of 30-50 μm. The substrate was subsequently seeded and cleaned as disclosed in Example 1.

The substrate was coated with a layer of diamond in a hot filament chemical vapour deposition system with a tantalum filament array configured for uniform deposition over a part sphere. The conditions used were a hydrogen, 1% methane gas mixture at a total flow rate of between 600 and 700 sccm, a chamber pressure of 6.5×10³ (50 Torr) and a filament temperature measured using an optical pyrometer of between 1700° C. and 1900° C. A substrate temperature of 830° C. was maintained by adjusting the cooling to the substrate. Growth was continued until the layer thickness was between 150 and 200 μm.

On removal from the deposition system, the CVD diamond layer was found to be well adhered. The layer was subsequently processed by lapidary techniques to a surface roughness, as characterised by its Ra, of better than 20 nm and a sphericity of better than 10 μm. During processing there was no evidence of delamination. In contrast, part spheres without the structured surface can similarly be coated with CVD diamond, but it is usually found that there is at least some delamination during processing.

1. A method of producing a diamond coated surface on a substrate, the method including the steps of preparing a surface of the substrate by exposing it to an electron beam to provide three dimensional features in the form of re-entrant holes in the substrate surface and/or surface features that protrude from the substrate surface, and applying a diamond layer to the prepared surface.

2. A method according to claim 1, wherein a number of locations on the surface are exposed to the power beam.

3. A method according to claim 1, wherein a number of periodically spaced locations on the surface are exposed to the power beam.

4. A method according to claim 1, wherein the applied diamond layer is polycrystalline in nature.

5. A method according to claim 4, wherein the grain size of the polycrystalline diamond adjacent the interface with the substrate surface is controlled so as to be smaller than the characteristic spacing of the three dimensional features.

6. A method according to claim 1, wherein the diamond layer is deposited on the substrate surface by chemical vapour deposition.

7. A method according to claim 6, wherein the prepared substrate surface is seeded prior to diamond deposition taking place.

8. A method according to claim 7, wherein seeding takes place by placing the prepared substrate surface in a suspension of diamond particles and agitating the suspension by ultrasonic means to cause seeding.

9. A method according to claim 7, wherein seeding takes place by bombarding the prepared substrate surface with diamond particles in a gas stream or liquid stream at a velocity sufficient to cause seeding.

10. A method according to claim 1, wherein the substrate material is ceramic, metal, or a metal alloy.

11. A method according to claim 1, wherein the substrate material is selected from carbides, oxides, nitrides, titanium metal or a titanium-containing alloy, tungsten or a tungsten-containing alloy, and molybdenum or a molybdenum-containing alloy.

12. A method according to claim 1, wherein the substrate is formed of tungsten or an alloy of predominantly tungsten.

13. A method according to claim 1, wherein the substrate is formed of molybdenum or an alloy of predominantly molybdenum.

14. A method according to claim 1, wherein the substrate is formed of titanium or an alloy of predominantly titanium.

15. A method according to claim 1, wherein the three dimensional features are provided in a periodic array.

16. A method according to claim 1, wherein the three dimensional features that protrude from the prepared surface and/or the re-entrant holes that extend below the prepared surface have respective heights, depths and diameters in the range 5 to 1000 μm.

17. A method according to claim 16, wherein the three dimensional features have respective h eights, depths and diameters in the range 10 to 5000 μm.

18. A method according to claim 17, wherein the three dimensional features have respective heights, depths and diameters in the range 25 to 250 μm.

19. A method according to claim 1, wherein those three dimensional features that protrude above the prepared surface have heights that are between 5% and 80% of the thickness of the diamond layer applied to the prepared surface.

20. A method according to claim 19, wherein the three dimensional features that protrude above the prepared surface have heights that are between 15% and 50% of the thickness of the diamond layer applied to the prepared surface.

21. A method according to claim 1, wherein the spacing of respective three dimensional features is 1.5 to 20 times their respective diameters.

22. A method according to claim 1, wherein the diamond coated surface is located on an electronic or optical device, cutting tool, drill bit, heat sink or is a low friction bearing or wear surface.
